(19) United States
(12) Patent Application Publication
(10) Pub. No.: US 2021/0326974 A1
(43) Pub. Date: Oct. 21, 2021

(54) BLOCKCHAIN-BASED OUTSOURCING PROCESSING METHOD AND PLATFORM

(71) Applicant: GUANGDONG UNIVERSITY OF TECHNOLOGY, Guangzhou (CN)

(72) Inventors: Jiewu LENG, GUANGZHOU (CN); Man ZHOU, GUANGZHOU (CN); Yuxuan XIAO, GUANGZHOU (CN); Longzhang LI, GUANGZHOU (CN); Qiang LIU, GUANGZHOU (CN); Haochi PAN, GUANGZHOU (CN); Zihan LI, GUANGZHOU (CN); Zhangyi WANG, GUANGZHOU (CN); Jingyi CAI, GUANGZHOU (CN); Shuer LIN, GUANGZHOU (CN)

(21) Appl. No.: 17/134,366

(22) Filed: Dec. 26, 2020

(30) Foreign Application Priority Data
Apr. 17, 2020 (CN) 202010304022.2

(51) Int. Cl. G06Q 30/08; G06F 30/20; H04L 9/08; H04L 9/06

(52) U.S. Cl. CPC G06Q 30/08; G06F 30/20; G06F 2111/02; H04L 9/0618; H04L 2209/38; H04L 9/0825

(57) ABSTRACT

The disclosure relates to a blockchain-based outsourcing processing method, including the steps of: transmitting, by a demander, product demand information to a network data server to form a demand order, and transmitting, by a supplier, self-processing capability information to the network data server; performing, by the network data server, matching according to the demand information and the processing capability information, and transmitting the demand order to the supplier; selecting, by the supplier, the demand order to quote; confirming, by the two parties, quotation, establishing transaction and generating a smart contract, and writing the smart contract into a blockchain for storage; and after completing goods delivery, automatically executing account transfer according to the smart contract to complete outsourcing processing transaction.

### CROSS REFERENCES TO RELATED APPLICATIONS

The present application claims foreign priority of Chinese Patent Application No. 202010304022.2, filed on Apr. 17, 2020 in the State Intellectual Property Office of China, the disclosures of all of which are hereby incorporated by reference.

### TECHNICAL FIELD

The disclosure relates to the field of blockchain technologies, and more particularly, to a blockchain-based outsourcing processing method and platform.

### BACKGROUND

With the improvement of mechanization, automation and digitalization of the whole industry and increasing demands for personalized products, small and medium-sized manufacturing industries are unable to complete one or more tasks independently due to a low production capacity, a single transaction mode, a large product demand fluctuation and a low production quantity. Meanwhile, as a supplier, it is difficult to find a processing order capable of being completed by the small and medium-sized supplier, and the small and medium-sized supplier is facing a crisis of reforming, upgrading or being eliminated by the market.

Under such circumstances, the small and medium-sized manufacturing industries may adopt an outsourcing processing method to make up for their shortcomings. The outsourcing processing refers to a process of ordering or customizing some parts or semi-finished products from other places or units by making full use of social stock resources when it is difficult for a manufacturer to independently complete an overall manufacturing and processing task due to deficiencies in equipment or technology, or higher costs are required to meet a same quality requirement, so as to ensure that the task is completed on time and the costs are reduced.

However, under the mode of the existing traditional industrial supply chain, it is difficult for a demander and a supplier to efficiently and accurately find a supplier capable of performing outsourcing processing or an order capable of being completed by the supplier through a hierarchical supply chain. For example, a referral company is often encountered, which finds a next supplier after receiving a demand order and passes on the demand order to the next supplier to earn a difference. Moreover, in a process of seeking cooperation between the supplier and the demander, information such as demand information or transaction information is easy to leak, with a problem of high trial and error cost.

### SUMMARY

The disclosure provides a blockchain-based outsourcing processing method and platform to solve the above problem that a demander and a supplier of an enterprise can efficiently and accurately find a supplier meeting needs of the demander or a demand order, and only a corresponding supplier is matched according to information of the demander, so that the demander can efficiently and accurately find the supplier, while the supplier can efficiently and accurately find the demand order.

In order to solve the above technical problems, the disclosure employs the technical solutions as follows: a blockchain-based outsourcing processing method includes: transmitting, by a demander, product demand information to a network data server to form a demand order, and transmitting, by a supplier, self-processing capability information to the network data server; performing, by the network data server, matching according to the demand information and the processing capability information, and transmitting the demand order to the supplier;

selecting, by the supplier, the demand order to quote; confirming, by the two parties, quotation, establishing transaction and generating a smart contract, and writing the smart contract into a blockchain for storage; storing the smart contract in the blockchain, which cannot be modified, so that transaction information is ensured to be not tampered, thus guaranteeing rights and interests of the two parties; and

after completing goods delivery, automatically executing account transfer according to the smart contract to complete outsourcing processing transaction.

By matching information of the demander with information of the supplier, a suitable supplier can be quickly found for the demander, after the two parties reach a transaction contract, the transaction contract is stored through the blockchain, and after transaction is completed, account transfer is executed through the smart contract, thus improving a convenience and a confidentiality of the transaction.

Preferably, after the supplier makes the quotation, the supplier and the demander are capable of bargaining automatically through the network data server. The automatic bargaining method is that: quotations of the demander and the supplier include ideal prices and bargaining ranges; and when executing automatic bargaining, the ideal prices of the demander and the supplier are summed to obtain an average, and the average is checked whether to be within the bargaining ranges of the two parties; if the average is within the bargaining ranges of the two parties, then the bargaining is successful, and the transaction is executed; and if the average is not within the bargaining ranges of the two parties, bargaining failure information is returned to the two parties. The automatic bargaining can shorten time for concluding the transaction, and improve an efficiency for concluding the transaction.

Preferably, asymmetric encryption is used in the network data server to encrypt CAD data of a processing model, and the CAD data is submitted to a monitoring page driven by a digital twin model to feed back a processing condition in real time. The demander may monitor a processing progress through the network.

Preferably, the demand information includes product-related information which includes a processing category, a processing quantity, processing technology level and precision requirements, and a processing deadline; and self-processing capacity information which comprises a production capacity, a production category, and production and processing technology information possessed. The processing category is matched with the production category, the processing quantity is matched with the production capacity, and the production and processing technology information is matched with the processing technology level and precision requirements during matching, and by matching the information of the two parties one by one, the demander can more efficiently and accurately find the supplier of outsourcing processing.

The disclosure further provides a blockchain-based outsourcing processing platform, which includes a broadcasting module configured to receive information of a demander and a supplier and transmit the information, a smart matching module configured to match the information of the demander with the information of the supplier received by the broadcasting module, an automatic bargaining module configured to generate a transaction contract according to quotation of the supplier, and a smart transfer module configured to automatically execute transaction, wherein after the automatic bargaining module writes the reached transaction contract into a blockchain, the smart transfer module acquires the transaction contract in the blockchain and executes the transaction.

The demander transmits demand information including the processing category, the processing quantity, the processing technology level and precision requirements, the processing deadline, and other information to the platform, while the supplier transmits the self-processing capacity information including the production capacity, the production category, the production and processing technology, and other information to the platform, the matching module matches the supplier with the demander, after the matching is completed, the broadcasting module transmits the demand information of the demander to the supplier, and the supplier makes quotation through the automatic bargaining module, and feeds back the quotation and self-information to the demander through the broadcasting module, and after the two parties conclude the transaction, the automatic bargaining module generates the transaction contract. After the transaction is completed, the automatic transfer module makes payment according to the transaction contract.

Preferably, the blockchain-based outsourcing processing platform further includes an encryption transmission module and a progress monitoring module; and

the encryption transmission module encrypts data of a processing model in an asymmetric encryption mode, then transmits the encrypted data to a digital twin model in the progress monitoring module, and feeds back a progress condition. Asymmetric encryption (public key encryption) is a security measure used in the disclosure, and CAD data is converted into random codes (encrypted) for transmission by technical means, and then restored (decrypted) after receiving the random codes.

Preferably, the automatic bargaining module further includes an automatic bargaining unit, the automatic bargaining unit acquires ideal prices and bargaining ranges of the demander and the supplier through the broadcasting module, sums the ideal prices first and then obtains an average, and verifies whether the average is within the bargaining ranges of the two parties; if the average is within the bargaining ranges of the two parties, the bargaining is successful; and if the average is not within the bargaining ranges of the two parties, bargaining failure information is returned to a user.

Preferably, the automatic bargaining module further includes an encryption unit, and the demander and the supplier view bargaining information through a key generated by the encryption unit. A user owns quotation information of input commodity, and may obtain encrypted information through private key encryption calculation, but other participants without a public key cannot obtain any information, thus implementing a confidential bargaining function.

An automatic bargaining calculation method is used to meet a requirement of not revealing any data privacy information in the transaction. With the help of homomorphic encryption, the automatic bargaining is capable of calculating a ciphertext without decrypting the ciphertext, thus indirectly calculating a plaintext.

Preferably, the smart matching module includes a database storing a processing procedure, and the smart matching module acquires processing technology information of the supplier and compares the processing technology information with data in the database to generate a recommendation report containing production data. The database covers most processing procedures during factory processing, which quantifies various operating units in the processing procedures, including but being not limited to processing time, a processing speed, and a processing technology level, and the operating units are inputted into the database. Therefore, when the factory only needs to input each designated procedure of an original production line and a newly introduced production line and related parameters thereof (such as a duration of each step, a processing mode, and the like), the platform may judge resulting data (such as a time cost, a raw material utilization rate, carbon emission, and the like) generated thereof through an algorithm. For one demand order, a recommendation report is generated, and the supplier may consider whether to receive the order with the help of data in the report.

Compared with the prior art, the disclosure has the beneficial effects that: by the outsourcing processing method and platform of the disclosure, the demander can efficiently and accurately find the supplier capable of meeting processing and production requirements of the demander, and complement a processing capacity that the demander lacks through cooperation, so that multiple processing tasks are completed; and the supplier can also efficiently and accurately complete the demand order capable of being independently completed by the supplier.

### BRIEF DESCRIPTION OF THE DRAWINGS

FIG. 1 is a flow chart of a blockchain-based outsourcing processing method according to the disclosure; and

FIG. 2 is a structure diagram of a blockchain-based outsourcing processing platform according to the disclosure.

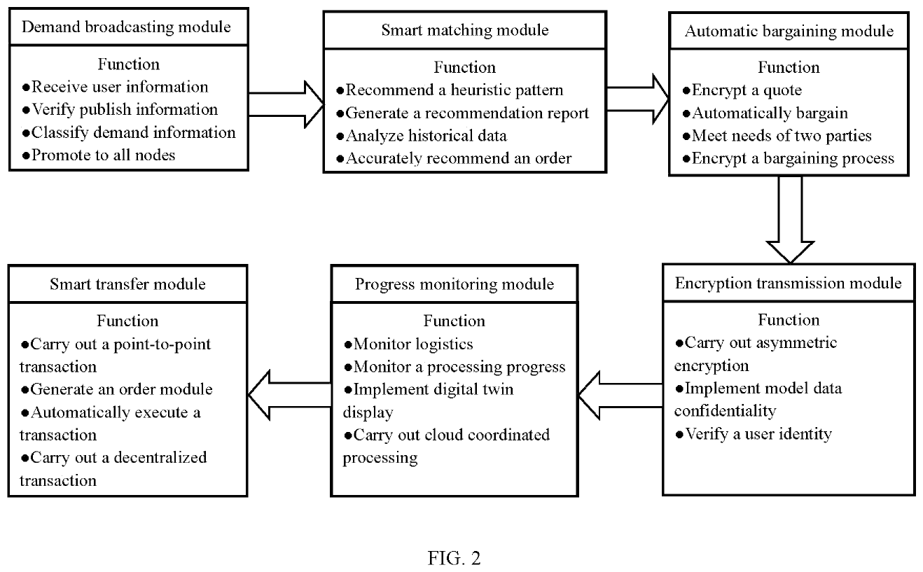

### DETAILED DESCRIPTION

The drawings are only for illustrative purposes, and cannot be understood as limiting the patent. In order to better illustrate the embodiments, some parts of the drawings may be omitted, enlarged or shrunk, and do not represent sizes of actual products. For those skilled in the art, it is understandable that some well-known structures in the drawings and the descriptions may be omitted. The positional relationship described in the drawings is only for illustrative purposes, and cannot be understood as limiting the patent.

The technical solutions of the disclosure are further described in detail hereinafter with reference to the specific embodiments and the accompanying drawings.

### Embodiment 1

An embodiment of a blockchain-based outsourcing processing method includes the following steps.

In step 1, product demand information is transmitted by a demander to a network data server to form a demand order, and self-processing capability information is transmitted by a supplier to the network data server.

In step 2, matching is performed by the network data server according to the demand information and the processing capability information, and the demand order is transmitted to the supplier.

In step 3, the demand order is selected by the supplier to quote; and after the supplier makes the quotation, the supplier and the demander are capable of bargaining automatically through the network data server.

In step 4, after the two parties confirm the quotation, the transaction is established and the smart contract is generated, and the smart contract is written into the blockchain for storage; and the smart contract is stored in the blockchain, which cannot be modified, so that transaction information is ensured to be not tampered, thus guaranteeing rights and interests of the two parties.

In step 5, asymmetric encryption is used in the network data server to encrypt CAD data of a processing model, and the CAD data is submitted to a monitoring page driven by a digital twin model to feed back a processing condition in real time. The demander may monitor a processing progress through the network.

In step 6, after goods delivery is completed, account transfer is automatically executed according to the smart contract to complete outsourcing processing transaction.

By matching information of the demander with information of the supplier, a suitable supplier can be quickly found for the demander, after the two parties reach a transaction contract, the transaction contract is stored through the blockchain, and after the transaction is completed, account transfer is executed through the smart contract, thus improving a convenience and a confidentiality of the transaction.

Specifically, the automatic bargaining method is that: quotations of the demander and the supplier comprise ideal prices and bargaining ranges; and when executing automatic bargaining, the ideal prices of the demander and the supplier are summed to obtain an average, and the average is checked whether to be within the bargaining ranges of the two parties; if the average is within the bargaining ranges of the two parties, then the bargaining is successful, and the transaction is executed; and if the average is not within the bargaining ranges of the two parties, bargaining failure information is returned to the two parties. The automatic bargaining can shorten time for concluding the transaction and improve an efficiency for concluding the transaction.

In this embodiment, the demand information includes product-related information which includes a processing category, a processing quantity, processing technology level and precision requirements, and a processing deadline; and self-processing capacity information which includes a production capacity, a production category, and production and processing technology information possessed. The processing category is matched with the production category, the processing quantity is matched with the production capacity, and the production and processing technology information is matched with the processing technology level and precision requirements during matching, and by matching the information of the two parties one by one, the demander can more efficiently and accurately find the supplier of outsourcing processing.

The embodiment has the beneficial effects that: the demander can efficiently and accurately find the supplier capable of meeting processing and production requirements of the demander, and complement a processing capacity that the demander lacks through cooperation, so that multiple processing tasks are completed; and the supplier can also efficiently and accurately complete the demand order capable of being independently completed by the supplier.

### Embodiment 2

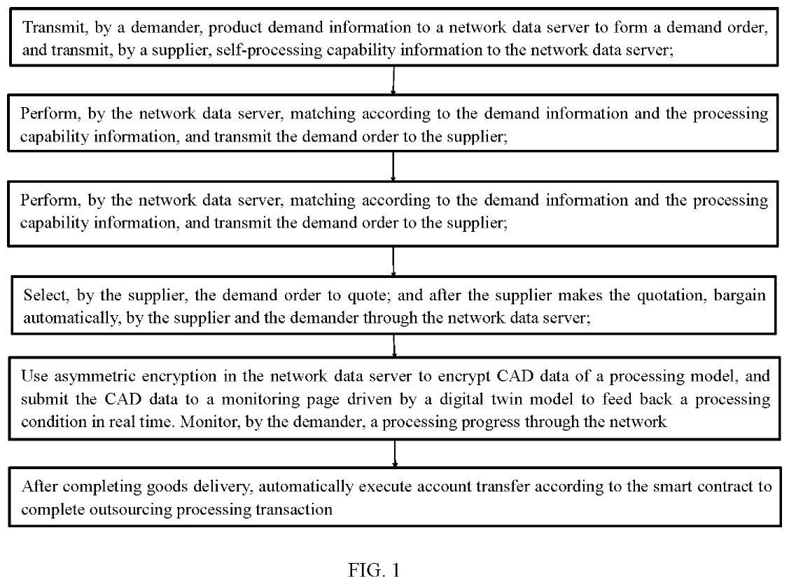

As shown in FIG. 1, a blockchain-based outsourcing processing platform includes a broadcasting module configured to receive information of a demander and a supplier and transmit the information, a smart matching module configured to match the information of the demander with the information of the supplier received by the broadcasting module, an automatic bargaining module configured to generate a transaction contract according to quotation of the supplier, and a smart transfer module configured to automatically execute transaction, wherein after the automatic bargaining module writes the reached transaction contract into a blockchain, the smart transfer module acquires the transaction contract in the blockchain and executes the transaction.

In this embodiment, the platform further includes an encryption transmission module and a progress monitoring module. The encryption transmission module encrypts data of a processing model in an asymmetric encryption mode, then transmits the encrypted data to a digital twin model in the progress monitoring module, and feeds back a progress condition. Asymmetric encryption (public key encryption) is a security measure used in the disclosure, and CAD data is converted into random codes (encrypted) for transmission by technical means, and then restored (decrypted) after receiving the random codes.

The automatic bargaining module further includes an automatic bargaining unit, the automatic bargaining unit acquires ideal prices and bargaining ranges of the demander and the supplier through the broadcasting module, sums the ideal prices first and then obtains an average, and verifies whether the average is within the bargaining ranges of the two parties; if the average is within the bargaining ranges of the two parties, the bargaining is successful, and if the average is not within the bargaining ranges of the two parties, bargaining failure information is returned to a user.

Further, the automatic bargaining module further includes an encryption unit, and the demander and the supplier view bargaining information through a key generated by the encryption unit. A user owns quotation information of input commodity, and may obtain encrypted information through private key encryption calculation, but other participants without a public key cannot obtain any information, thus implementing a confidential bargaining function.

A user owns quotation information of input commodity, and may obtain encrypted information through private key encryption calculation, but other participants without a public key cannot obtain any information, thus implementing the confidential bargaining function.

An automatic bargaining calculation method is used to meet a requirement of not revealing any data privacy information in the transaction. With the help of homomorphic encryption, the automatic bargaining is capable of calculating a ciphertext without decrypting the ciphertext, thus indirectly calculating a plaintext.

The user may obtain a key generation tool provided by the platform through unique ID during platform registration, and after the user obtains the generation tool, the user may locally generate the public and private keys. The public key may be transmitted to the platform for verification of user quotation. Meanwhile, bargaining demand information of the user will be transmitted to the platform for the automatic bargaining module after being encrypted through the private key.

In addition, the smart matching module includes a database storing a processing procedure, and the smart matching module acquires processing technology information of the supplier and compares the processing technology information with data in the database to generate a recommendation report containing production data. A database covers most processing procedures during factory processing, which quantifies various operating units in the processing procedures, including but being not limited to processing time, a processing speed, and a processing technology level, and the operating units are inputted into the database. Therefore, when the factory only needs to input each designated procedure of an original production line and a newly introduced production line and related parameters thereof (such as a duration of each step, a processing mode, and the like), and the platform may judge resulting data (such as a time cost, a raw material utilization rate, carbon emission, and the like) generated thereof through an algorithm. For one demand order, a recommendation report is generated, and the supplier may consider whether to receive the order with the help of data in the report.

A working principle and a working flow of this embodiment are that: the demander transmits demand information including the processing category, the processing quantity, the processing technology level and precision requirements, the processing deadline, and other information to the platform, while the supplier transmits self-processing capacity information including the production capacity, the production category, the production and processing technology, and other information to the platform, the matching module matches the supplier with the demander. After the matching is completed, the broadcasting module transmits the demand information of the demander to the supplier, and the supplier makes quotation through the automatic bargaining module, and feeds back the quotation and the information of the supplier to the demander through the broadcasting module, and after the two parties conclude the transaction, the automatic bargaining module generates the transaction contract. After the transaction is completed, the automatic transfer module makes payment according to the transaction contract.

The embodiments have the beneficial effects that: by the outsourcing processing method and platform according to the embodiments, the demander can efficiently and accurately find the supplier capable of meeting processing and production requirements of the demander, and complement a processing capacity that the demander lacks through cooperation, so that multiple processing tasks are completed; and the supplier can also efficiently and accurately complete the demand order capable of being independently completed by the supplier.

Obviously, the above-mentioned embodiments of the disclosure are merely examples for clearly illustrating the disclosure, but are not intended to limit the implementations of the disclosure. For those of ordinary skills in the art, other different forms of changes or variations can be made on the basis of the above description. It is not necessary or possible to exhaust all the implementations here. Any modifications, equivalent substitutions, and improvements made within the spirit and principle of the disclosure shall all fall within the scope of protection claimed by the disclosure.

What is claimed is:

1. A blockchain-based outsourcing processing method, comprising: transmitting, by a demander, product demand information to a network data server to form a demand order, and transmitting, by a supplier, self-processing capability information to the network data server; performing, by the network data server, matching according to the demand information and the processing capability information, and transmitting the demand order to the supplier;
selecting, by the supplier, the demand order to quote; confirming, by the two parties, quotation, establishing transaction and generating a smart contract, and writing the smart contract into a blockchain for storage; and
after completing goods delivery, automatically executing account transfer according to the smart contract to complete outsourcing processing transaction.

2. The block-chain based outsourcing processing method according to claim 1, wherein after the supplier makes the quotation, the supplier and the demander are capable of bargaining automatically through the network data server.

3. The block-chain based outsourcing processing method according to claim 2, wherein the automatic bargaining method is that: quotations of the demander and the supplier comprise ideal prices and bargaining ranges; and when executing automatic bargaining, the ideal prices of the demander and the supplier are summed to obtain an average, and the average is checked whether to be within the bargaining ranges of the two parties; if the average is within the bargaining ranges of the two parties, then the bargaining is successful, and the transaction is executed; and if the average is not within the bargaining ranges of the two parties, bargaining failure information is returned to the two parties.

4. The blockchain-based outsourcing processing method according to claim 1, wherein asymmetric encryption is used in the network data server to encrypt CAD data of a processing model, and the CAD data is submitted to a monitoring page driven by a digital twin model to feed back a processing condition in real time.

5. The blockchain-based outsourcing processing method according to claim 1, wherein the demand information comprises product-related information which comprises a processing category, a processing quantity, processing technology level and precision requirements, and a processing deadline; and self-processing capacity information which comprises a production capacity, a production category, and production and processing technology information possessed.

6. A blockchain-based outsourcing processing platform, comprising a broadcasting module configured to receive information of a demander and a supplier and transmit the information, a smart matching module configured to match the information of the demander with the information of the supplier received by the broadcasting module, an automatic bargaining module configured to generate a transaction contract according to quotation of the supplier, and a smart transfer module configured to automatically execute transaction; wherein after the automatic bargaining module writes the reached transaction contract into a blockchain, the smart transfer module acquires the transaction contract in the blockchain and executes the transaction.

7. The blockchain-based outsourcing processing platform according to claim 6, further comprising an encryption transmission module and a progress monitoring module, wherein:
the encryption transmission module encrypts data of a processing model in an asymmetric encryption mode, then transmits the encrypted data to a digital twin model in the progress monitoring module, and feeds back a progress condition.

8. The blockchain-based outsourcing processing platform according to claim 6, wherein the automatic bargaining module further comprises an automatic bargaining unit, the automatic bargaining unit acquires ideal prices and bargaining ranges of the demander and the supplier through the broadcasting module, sums the ideal prices first and then obtains an average, and verifies whether the average is within the bargaining ranges of the two parties; if the average is within the bargaining ranges of the two parties, the bargaining is successful, and if the average is not within the bargaining ranges of the two parties, bargaining failure information is returned to a user.

9. The blockchain-based outsourcing processing platform according to claim 6, wherein the automatic bargaining module further comprises an encryption unit, and the demander and the supplier view bargaining information through a key generated by the encryption unit.

10. The blockchain-based outsourcing processing platform according to claim 6, wherein the smart matching module comprises a database storing a processing procedure, and the smart matching module acquires processing technology information of the supplier and compares the processing technology information with data in the database to generate a recommendation report containing production data.
